(19) United States
(12) Patent Application Publication
(10) Pub. No.: US 2026/0008568 A1
(43) Pub. Date: Jan. 8, 2026

(54) Unmanned aerial system for autonomous product delivery and pickup

(71) Applicant: Pedro Genoves Ramirez, Leganes (ES)

(72) Inventor: Pedro Genoves Ramirez, Leganes (ES)

(21) Appl. No.: 18/993,596

(22) PCT Filed: Mar. 9, 2023
(86) PCT No.: PCT/ES2023/070127

§ 371 Date: Jan. 13, 2025

(30) Foreign Application Priority Data
Jul. 13, 2022 (ES) P202230642

(51) Int. Cl. B64U 10/13; B64D 1/08; B64F 1/32; B64U 101/64

(52) U.S. Cl. CPC B64U 10/13; B64D 1/08; B64F 1/32; B64U 2101/64

(57) ABSTRACT

The claimed unmanned aerial system for autonomous delivery and collection of products is designed to optimize capillary deliveries to the final recipients of products and goods and on the other hand, drastically reduce disposable packaging waste in the current process. It is mainly composed of
KAT (Kit of Landing) is the component that the recipient has at home fully automated and that is positioned exclusively when the product arrives to be delivered.
KAS (Kit Aerial Supply) corresponds to the component that is attached to the aerial equipment that delivers the product.
UDER (Unit Of Reusable Delivery), is a unitized, reusable container with a lid that is adapted to the KAS for product delivery and empty container removal operations.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The field of the invention is within the logistics industry, especially the one known as last logistics

### Description of Related Art

There are some isolated and independent precedents on systems that meet some of the parameters of the invention we advocate.

Among it we have detected the invention of the company The SkyLife INC (USA), which in summary comprises “an aerial distribution system for deploying items, comprising a bulk shipping container of a plurality of deployment boxes (4000, 4100) within the bulk shipping container, each deployment box containing at least at least at least one item, characterized in that the aerial distribution system comprises both a plurality of ropes (4020), each rope coupled to a deployment box of the bulk shipping container and a free fall delay device coupled to the bulk shipping container, wherein during the delayed free fall each of the plurality of deployment boxes deploys from the bulk shipping container and deploys at least one item contained within the deployment box.

We consider this file as a remote antecedent and none of its developments can be considered as a noteworthy antecedent.
Chinese patent file P CN201711255909.
From application date 2017 Dec. 3
Application filed by China Helicopter Research and Development Institute
For “Cargo distribution system and method based on unmanned aerial vehicle

### Abstract

The invention relates to the technical field of unmanned aerial vehicle application, in particular to a cargo distribution system and a cargo distribution method based on an unmanned aerial vehicle; the delivery system includes: the order generating module is used for generating an order according to the order placing requirement of the user, and the order at least comprises commodity information and user address information; the goods receiving station is configured to receive goods to be delivered and the unmanned aerial vehicle, which are borne by the unmanned aerial vehicle; the route configuration module is used for selecting the address of the cargo receiving station closest to the address of the user according to the order information and then generating delivery route information for the unmanned aerial vehicle; the unmanned aerial vehicle is used for bearing goods to be delivered and flying according to the control command; and the unmanned aerial vehicle flight control module is used for sending a control instruction for controlling the unmanned aerial vehicle to fly according to the delivery route information. The cargo distribution system and the distribution method based on the unmanned aerial vehicle have the advantages that the cargo distribution efficiency is higher, the distribution cost is lower, and the distribution punctuality can be ensured.

This document refers to a general distribution system but at no point does it provide the direct logistics elements that the recommended invention provides.

On the part of the inventor there is no known prior art incorporating the provisions presented by the present invention, nor the advantages of such provision.

### BRIEF SUMMARY OF THE INVENTION

The invention refers to an unmanned aerial system for autonomous delivery and collection of products, i.e. the system does not require the manipulation of operators or users to perform its function.

The system is primarily designed to optimize capillary deliveries to final recipients of products and goods.

The main advantages provided by the present invention can be summarized as follows:
Very fast deliveries
Fully automated process between the logistics company and the customer.
Total reduction of disposable packaging

Convenience for recipients of not having to be at home to pick up
product
   Significant reduction in logistics costs,
   Reduction of up to 50% of CO2 emissions to the atmosphere compared with the current capillary distribution system with combustion engines

### BRIEF DESCRIPTION OF THE DRAWINGS

For a better understanding of the invention a drawing sheet is attached in which the following figures are shown:

FIG. 1.

Schematic sectional view of the loading equipment 2.

FIG. 2.

Schematic sectional view of a recyclable container model.

FIG. 2.1.

Detail schematic section view of the connection of the cover with the bottom recyclable container

FIG. 3.

Schematic sectional view of the receiving equipment 3 in the idle state

FIG. 4.

Schematic sectional view of the receiving equipment 3 starting up and preparing the receiving arm.

FIG. 5

Schematic sectional view of the receiving equipment 3 in working order awaiting the arrival of the drone with the goods and the removal container on its position.

And in these figures, with the same reference, identical elements are named, among which we distinguish:
(20).—automatic opening/closing bracket that allows any drone to open/close it transport.
(21).—shaft of attachment to the drone,
(22).—loading hanger,
(22.1) and (22.2)—arms of the loading sling bar,
(23).—CPU for control and guidance of all the equipment.
(24).—night vision camera with approach and video sensor.
(25).—automatic axes for fastening the delivery and reception devices,
(26).—collection device,
(29).—container capture arms,
(30).—delivery device,
(31).—retaining tabs for delivery containers,
(32).—sensors for control and actuation of the retaining flanges of the delivery containers,
(33).—reusable transport,
(34).—Immobilization bars for transport containers,
(35).—transport container lids,
(36)—lower container of the transport container,
(37).—through bores of transport containers,
(38).—closing/opening device for transport containers
(39)—axis of rotation
(40).—support column, cylindrical element that will house the rest of the elements necessary for the work of reception and removal of returns,
(41).—upper and lower base of the support column,
(42).—Hydraulic device for height adjustment of the support column,
(43).—presence sensor, localization and activation of the receiving and receiving equipment and withdrawal of returns,
(44)—Unit control CPU,
(45)—Extendable equipment support arm,
(46).—opening joint of the extendable arm,
(47).—arm support of delivery and collection of goods,
(48).—notch for dropping off recyclable, used or returned transport containers,
(49).—delivery collection basket,
(50).—electric motor for opening and unfolding of the equipment support arm;
(51)—Support frame for the collection basket.
(52).—cylindrical part,
(53).—inner brake,
(55)—notch of the recyclable container lid,
(56).—hydraulic balancing device,
(57).—arms of the hydraulic balancing device,
(60)—delivery device position sensors (30),
(61)—pick-up device position sensors (26),
(62)—return notch position sensors (48),
(63).—position sensors of the collection basket support frame (51),

### DETAILED DESCRIPTION OF THE INVENTION

The claimed system that we call SADUM (Last Mile Airborne System) is mainly conceived to optimize capillary deliveries to the final recipients of products and goods and, on the other hand, to drastically reduce the disposable packaging waste in the current process (cardboard boxes and cases, shrink-wrapping, wrapping paper, etc.).

### Objectives and Advantages

The following are the main:
Great speed in deliveries,
Fully automated process between the logistics company and the customer,
Total reduction of disposable packaging,
Convenience to the recipients of not having to be at home to pick up the product,
Significant reduction in logistics costs.

### Components

KAT (Kit of Landing) is the component that the recipient has at home fully automated and that is positioned exclusively when the product arrives to be delivered.

KAS (Kit Aerial Supply) corresponds to the component that is attached to the aerial equipment that delivers the product.

UDER (Unit Of Reusable Delivery), is a unitized, reusable container with a lid that is adapted to the KAS for product delivery and empty container removal operations.
Infrastructure: the system can operate with up to 4 components:
PLA (Air Launch Platforms)
EAP (Primary Aerial Equipment)
EAS (Secondary aerial equipment)
KAT (Landing Kit)
Applicability: The SADUM system can be applied to all types of products, some of them are listed below:
E-commerce shopping
Shopping for all types of food (a la carte menus, pizzas, hamburgers, etc.)
Purchases of medicines, pharmaceuticals in general, herbal products, etc.
Delivery of heavier industrial components between companies.
Operation: The operation of the SADUM system is designed to be as easy as possible for all operators involved in the process.
We can divide it into 4 main phases:
Filling and loading phase in logistics warehouse,
Waiting parking phase in PLA fixed aerial launching platform (existing in all cities with action radius of about 5000 m). In this phase the EAPs are loaded
(Primary Air Teams), with EAS (Secondary Air Teams) in destinations that require it due to greater distance.
Direct handover phase between PLA and KAT with EAS (Secondary Airborne Equipment Fully automated and coordinated landing phase at KAT between the KAT terminal and EAS.

During the UDER filling and EAS loading phase at the logistics operator's facilities, the goods from the different suppliers who sell ON LINE are palletized and shrink-wrapped without the need to pack each unit in cartons, etc., thus avoiding more packaging waste in the process.

For optimal functionality of the SADUM system, the KAT'S carry a plate with a QR code or similar GPS location to perform the most optimal route possible and fully automatically, 10 seconds before the EAS arrives at the destination, it sends a signal to the KAT to open and position itself and prepare for the landing phase. Once the EAS has landed at the KAT, the UDER is unloaded with the purchased product and in parallel, the empty UDER is picked up for its return to origin.

In the case of smaller volume and unit weight purchases, a KAS (Air Supply Kit) has been designed to allow several product deliveries (and their corresponding empty UDER'S pick-ups) at different destinations, exponentially increasing the delivery time of the products at each destination from the time the order is placed.

### Description of the Preferred Embodiment

The invention described herein refers to an unmanned aerial system for autonomous delivery and collection of products, i.e. the system does not require the manipulation of operators or users to perform its function.

The system is primarily designed to optimize capillary deliveries to final recipients of products and goods.

In a preferred embodiment the system consists of at least three pieces of equipment.
1.—Air distribution and returns removal team,
2.—Loading equipment
3.—Returns reception and withdrawal team.

All these steps will be carried out autonomously without the need for any user to manipulate the system at any time, nor is the user's presence necessary for the collection of the merchandise.

1.—The aerial equipment for the distribution and removal of returns is based on drones, a drone being understood as an unmanned aerial vehicle capable autonomously maintaining a controlled and sustained level of flight.

This first phase of filling and loading of the goods is carried out at the logistics operator's facilities, which include the drone base, the drone take-off and landing platforms and the internal storage and distribution facilities for the goods.

It has the goods coming from the different suppliers that sell ON LINE, palletized and shrink-wrapped without the need to pack each unit in individual cartons, plastic containers, etc., thus avoiding more packaging waste in the.

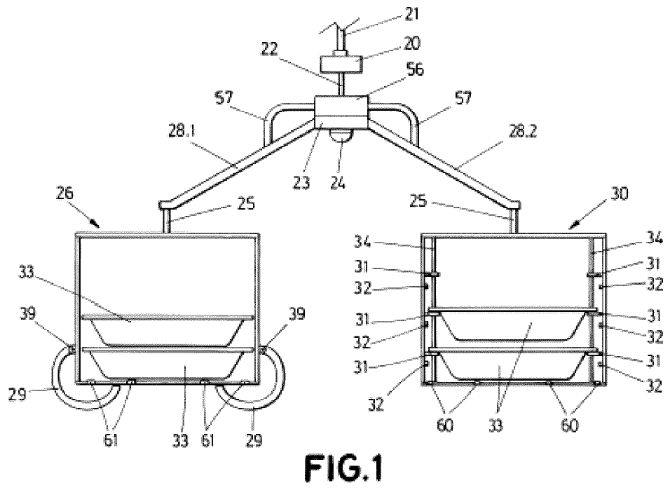

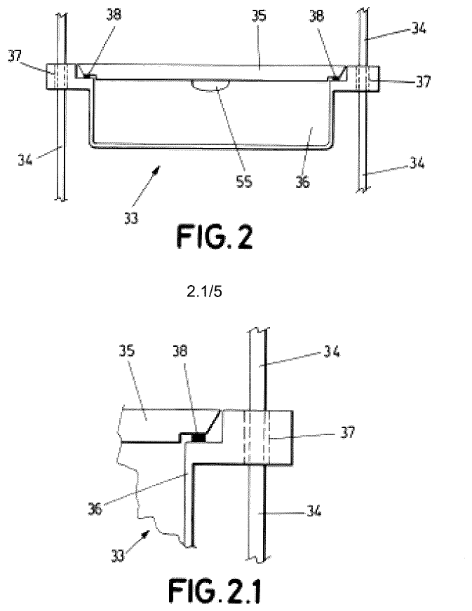

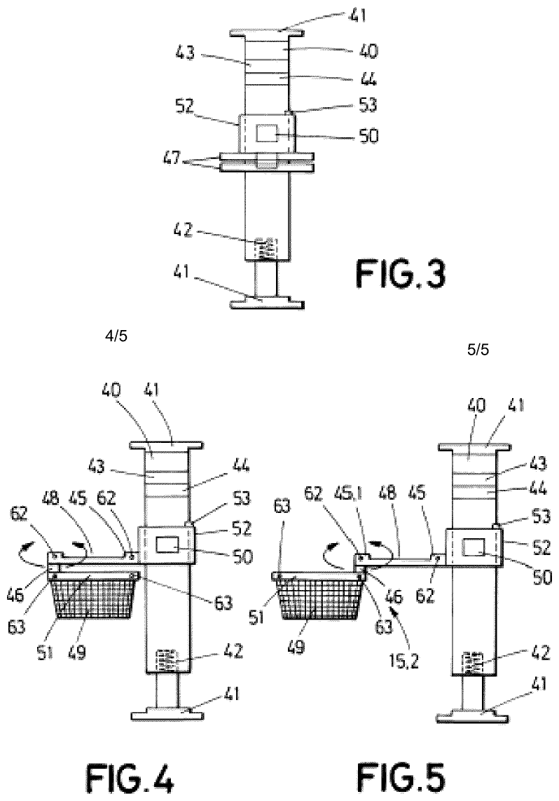

2.—The loading equipment with which the drone will distribute the products and remove the return products and/or empty reusable containers (30), is made up of the following elements contained in FIGS. 1 and 2.
Loading hanger (22) with two arms (22.1) and (22.2) that allows any drone to transport it and that at least consists of the following elements, as shown in FIGS. 3, 4 and 5.

The loading hanger (22) has an automatic opening/closing support (20) that allows any drone to transport it and the loading/unloading operations can be automated, so that in a line of hangers prepared for distribution, the drone by means of the fixing shaft (21) picks up the goods to be distributed or leaves the goods back for processing.

At the ends of the arms (22.1) and (22.2) of the loading hanger (22) there are automatic fixing shafts (25) for the support of the delivery (30) and pick-up devices (26).

The delivery device (30) consists of a preferably cubic container having on its side walls a set of retaining tabs (31) controlled and actuated by motion sensors (32) so that to deposit the reusable transport containers (33) in the user's tank the control system activates the sensor (32) which opens the tab (31) and by gravity the transport box is deposited in the appropriate receptacle.

In order that the transport boxes (33) do not move during movement, vertical fixing bars (34) are provided which pass through the reusable transport containers (33) through the holes (37), and in order that the delivery device (30) is correctly positioned on the receiving basket (49), position sensors (60) and (63) are positioned on the perimeter of the lower part of the delivery device (30) and on the support frame of the collecting basket (51).

The collection device (26) consists of a preferably cubic container having on its lower part catching arms (29) in the form of hooks and articulated by the lower part of the collection container (26) by means of a pivot axis (39).

These catching arms (29) when they reach the user's receiving equipment 2, imprison the reusable transport container (33) by means of the catching arms (29) and insert it into the container at the bottom.

In this way, the reusable transport containers (33) can be stored one after the other until the collection device (26) is completely filled.

In order for the collection device (26) to be correctly positioned over the receiving basket notch (49), position sensors (61) and (62) are positioned on the perimeter of the bottom of the collection device (26) and in the notch (48) of the recyclable, used or returned transport containers.

All equipment functions are controlled and monitored by means of a control CPU (23), aided by a built-in camera (24) that will feature day/night vision and video/photography.

The reusable transport containers (33) consist of a container with a lower container (36) and an upper lid (35) made of an environmentally friendly and reusable material and where the lower container (36) has an outer perimeter flange with two through holes (37) for the passage of fixing bars (34) that will keep the transport containers (33) perfectly stowed inside the delivery container (30) and also with two opposing notches (55) on its outer perimeter to be able to remove the upper lid (35).

3.—Equipment for the reception and removal of returns.

This equipment is made up of a main element consisting of a support column (40), preferably cylindrical, which will house all the elements necessary for the work of receiving products and removing both returns and empty reusable transport containers (33).

The support column (40) has two bases (41) at the top and at the bottom, which will be used for pressure clamping, pressure obtained by a mechanical or hydraulic height adjustment device (42).

The support column (40) has in its middle part and on the outside, a cylindrical part (52) with 360° circular movement and internal brake (53), which carries an extendable support arm (45) in two parts (45.1) and (45.2).

This extendable support arm (45) has a first part (45.1) solidary with the cylindrical part (52) and under it another elongated part (45.2) folded over the previous one and that by means of a joint (46) rotates and unfolds outwards.

The extendable part (45.1) has on its surface a notch (48) where a reusable transport container (33) fits, which can be empty for reuse or full for return.

Further towards the outer end of this part is a rigid frame (51) with a basket (49) where the corresponding drone will deposit the goods to be delivered.

All the mechanisms of the support column (40) are controlled by a control CPU (44) and to assist in the location, approach and positioning of the drone, the support column (40) has a geolocatable sensor (43) which, upon detecting the arrival of the drone, will rotate the circular part (50) and deploy the elongated parts (45.1) and (45.2) (45.2) by means of the electric motor (50) leaving the assembly in readiness for use.

Having sufficiently described the nature of the invention, as well as the manner of putting it into practice, it should be noted that the provisions previously indicated and represented in the attached drawings are susceptible to modifications e insofar as they do not alter their fundamental principles, set forth in the preceding paragraphs and summarized in the following claims.

1. Unmanned aerial system for autonomous delivery and collection of products characterized in that the system is made up of at least three interconnected devices:
1.—Airborne distribution and returns removal team,
2.—Loading equipment
3.—Returns reception and withdrawal team.
And where the aerial equipment for distribution and removal of returns 1 consists of a group of drones located on the premises of a logistics operator, each drone carrying a fixing axle (21) for the transport of loads.
And where the loading equipment 2 with which the drone will distribute the products and will remove the return products and/or the empty reusable containers (33), is constituted by a loading hanger (22) with two arms (22.1) and (22.2) that allows any drone to transport it by means of the shaft (21) hooked to an automatic opening/closing support (20), being located at the ends of the loading hanger (22.1) and (22.1) automatic fixing shafts (25) for the support of the delivery (30) and pick-up (26) devices that will carry the reusable transport containers (33), all the functions of the equipment being controlled and monitored by means of a control CPU (23), aided by a built-in camera (24) with day/night vision and video/photography, and the delivery device (30) is correctly positioned on the receiving basket (49), with the aid of position sensors (60) and (63) placed on the perimeter of the lower part of the delivery device (30) and on the support frame of the collection basket (51).
And where the equipment for the reception and removal of returns is constituted by a main element consisting of a cylindrical support column (40), which will house all the necessary elements for the work of reception of products and removal of both returns and empty reusable transport containers (33), for which it has two bases (41) both in its upper and lower part that will serve as pressure fastening, pressure obtained by a height adjustment device (42) of mechanical or hydraulic type, presenting in its middle part and on the outside, a cylindrical part (52) with 360° circular movement and inner brake (53), which has an extendable support arm (45) in two parts (45.1 and (45.2), being all the mechanisms (45.1) and (45.2) of the cylindrical support arm (45.1) and (45.2). Cylindrical part (52) with 360° circular movement and internal brake (53), which jointly carries an extendable support arm (45) in two pieces (45.1) and (45.2), all the mechanisms of the support column (40) being controlled by a control CPU (44) and a geolocatable sensor (43) which, upon detecting the arrival of the drone, will deploy the elongated part (45.2) by means of the electric motor (50) leaving the assembly in readiness for use.

2. Unmanned aerial system for autonomous delivery and collection of products according to the 1st claim characterized because the drone base is located in the facilities of a logistics operator that has the take-off and landing platforms of the same and the facilities for storage and internal distribution of goods.

3. Unmanned aerial system for autonomous delivery and collection of products according to the 1st claim and characterized in that the delivery device (30) consists of a cubic container having on its side walls a set of retention tabs (31) controlled and actuated by motion sensors (32). In order to deposit the reusable transport containers (33) in the user's container, the control system activates the sensor (32) which opens the flap (27) and by gravity the transport box is deposited in the appropriate receptacle and in order that the reusable transport containers (33) do not move during transport, bars are provided to prevent the reusable transport containers (33) from moving. The reusable transport containers (33) are provided with vertical fixing bars (34) which pass through the through holes (37) located on the outer perimeter edge of the reusable transport containers (33) so that the delivery device (30) is correctly positioned on the receiving basket (49), position sensors (60) and (63) are positioned on the perimeter of the lower part of the delivery device (30) and on the support frame of the collection basket (51).

4. Unmanned aerial system for autonomous delivery and collection of products according to the 1st claim and characterized in that the collection device (26) is constituted by a rectangular container which in its lower part has capture arms (29) in the form of hooks and articulated by the lower part of the collection container (26) by means of a rotating axis (39) and where these capture arms (29) when they reach the user's reception equipment 2, the reusable transport container (33) by means of the catching arms (29) and introduce it into the container from the lower part by consecutively storing the reusable transport containers (33) until the collection device (26) is completely filled, in order to ensure that the collection device (26) is correctly positioned over the receiving basket notch (49), position sensors (61) and (62) are positioned on the perimeter of the lower part of the collection device (26) and in the notch (48) of the recyclable, used or returned transport containers.

5. Unmanned aerial system for autonomous delivery and collection of products according to the 1st claim and characterized in that the reusable transport containers (33) consist of a container with a lower container (36) and an upper lid (35) retained between them by a magnetic closure (38) made of an ecological and reusable material that has an outer perimeter flange with two through holes (37) for the passage of fixing bars (38). magnetic closure (38) s made of an environmentally friendly and reusable material having an outer perimeter flange with two through holes (37) for the passage of fixing bars (34) which will keep the transport containers (33) perfectly stowed inside the delivery container (30).

6. Unmanned aerial system for autonomous delivery and collection of products according to the 1st claim and characterized because the extendable support arm (45) has a first piece (45.1) solidary with the cylindrical piece (52) and under it another elongated piece (45.2) and that by means of a joint (46) is deployed outwards and where the extendable piece (45.1) presents on its surface a notch (48) where fits a reusable transport container (33) that can be empty to reuse or to return and where the extendable piece (45.2) extended by means of the joint (46) has a rigid frame (51) that carries a basket (49) where the corresponding drone will deposit the goods to be delivered.
